(19) United States
(12) Patent Application Publication
(10) Pub. No.: US 2010/0280901 A1
(43) Pub. Date: Nov. 4, 2010

(54) SYSTEM AND METHOD FOR ADDING CONTENT, CONTESTS AND PROMOTIONS TO WEB PROPERTIES

(76) Inventors: Vincent Zaldivar, Las Vegas, NV (US); Mark Brown, Las Vegas, NV (US); Kevin Vonasek, Brighton, MA (US)

Correspondence Address: WEISS & MOY PC, 4204 NORTH BROWN AVENUE, SCOTTSDALE, AZ, 85251, US

(21) Appl. No.: 12/432,092

(22) Filed: Apr. 29, 2009

(51) Int. Cl. G06Q 30/00

(52) U.S. Cl. 705/14.53

(57) ABSTRACT

A method of adding advertisements and promotions to web properties has companies accessing an online gaming provider. Advertisement data of the companies to be displayed on a Massively Multi-player Online Game (MMOG) is loaded. Players are tagged as coming from websites of specific companies. Advertisement data is displayed on the MMOG, wherein each player views advertisement data from the specific company where the player was tagged as visiting.

### FIELD OF THE INVENTION

This invention relates to online advertising and, more specifically, to a system and process that allows registered users the ability of adding content, contests and promotions to web properties.

### BACKGROUND OF THE INVENTION

Massively Multi-player OnlineGames (MMOG) are video games that allow registered users the opportunity to play online games with other players logged in via the Internet. MMOGs can enable players to cooperate and or compete with each other on a large scale, and sometimes to interact meaningfully with people around the world.

Advertising on MMOGs is typically limited to banner type ads. Banner ads are small rectangular advertisements that generally appear around a perimeter of a Web page. Banner ads are designed to attract traffic to a website by linking to the website of the advertiser. Banner ads are generally constructed from an image (GIF, JPEG, PNG), JavaScript program or multimedia object employing technologies such as Silverlight, Java, Shockwave or Flash, often employing animation, sound, or video to maximize presence. When one moves a mouse icon over and clicks on the banner ad, the viewer is directed to the website advertised in the banner. This event is known as a “click through”. In many cases, banners are delivered by a central ad server.

Furthermore, game developers have been able to integrate ads and products at the time of creation, with game publishers and business development people bringing the advertisers. However, once the ads are integrated within the game, the ads are generally fixed and cannot be changed. Furthermore, because the game development process itself could take two years or more, the advertisements need to be determined long before they are seen by the target audience.

Therefore, a need existed to provide a system and method to overcome the above problem. The system and method would allow registered users the ability of adding content, contests and promotions to web properties.

### SUMMARY OF THE INVENTION

A method of adding advertisements and promotions to web properties has companies accessing an online gaming provider. Advertisement data of the companies to be displayed on a Massively Multi-player Online Game (MMOL) is loaded. Players are tagged as coming from websites of specific companies. Advertisement data is displayed on the MMOG, wherein each player views advertisement data from the specific company where the player was tagged as visiting.

The present invention is best understood by reference to the following detailed description when read in conjunction with the accompanying drawings.

### BRIEF DESCRIPTION OF THE DRAWINGS

FIG. 1 is a simplified block diagram of the system 10 using the present invention;

FIG. 2 is a screen shot of the affiliates registration page of the operator's website;

FIG. 3 is a screen shot of a login page of the operator's website;

FIG. 4 is a screen shot of an affiliates webpage having links to the operator's website;

FIG. 5 is a screen shot of a customized landing page of the present invention;

FIG. 6 is a screen shot registration page on the affiliates website for players to register to play online games on the operator's website;

FIG. 7 is a screen shot of an information page on the affiliates website for players who register to play online games on the operator's website;

FIG. 8 is a screen shot of an online game on the operator's website showing advertisements for the affiliate;

FIG. 9 is a screen shot of a leaderboard on the operator's website; and

FIG. 10 is a screen shot of a advertisement video on the operator's website.

Common reference numerals are used throughout the drawings and detailed description to indicate like elements.

### DETAILED DESCRIPTION

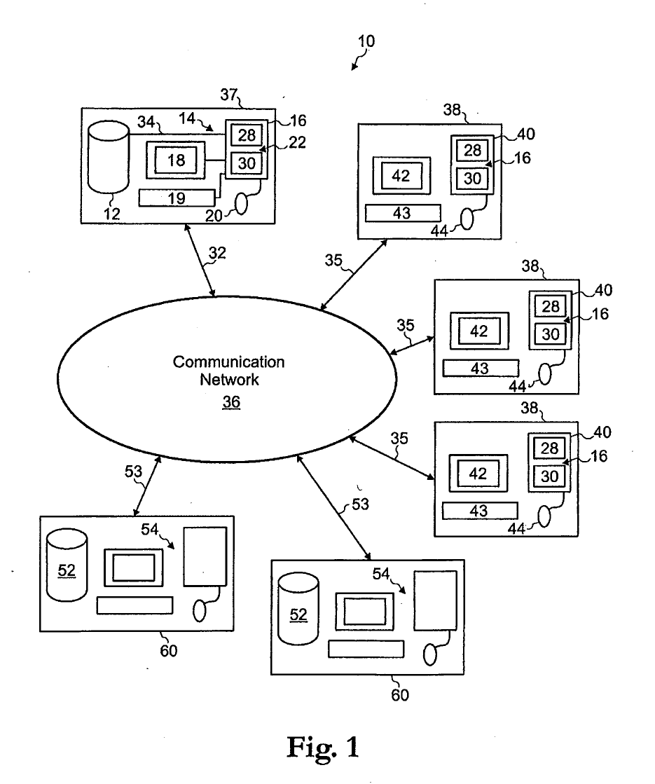

Referring now to FIG. 1, a simplified schematic of the system 10 of the present invention is shown. The system 10 allows users the ability of adding content, contests and promotions to web properties. The system 10 generally has a server 12. The server 12 is used for hosting a plurality of on-line gaming applications as well as templates for allowing registered users the ability to customize different on-line gaming applications.

The server 12 may be connected to a host computer system 14. The computer system 14 may have a processor unit 16 and a display 18. Input devices maybe coupled to the processor unit 16. The input devices may be a keyboard 19, a mouse 20 and the like.

The processor unit 16 may further have an I/O port 22 for downloading data to the processor unit 16. The I/O port 22 may be a USB port, a FireWire port or the like. The listing of the above is given as an example and should not be seen as to limit the scope of the present invention.

Through the execution of program instructions forming a computer program product within the computer system 14, the computer system 14 may provide a means that allows registered users the ability of adding content, contests and promotions to web properties and more specifically to allow registered users the ability to customize different on-line gaming applications. The program instructions maybe located within a memory 28 of the processor unit 16 and executed by a central processing unit 30 (CPU). Any data generated and or gathered from the running of the program instructions may be stored within a storage media, memory 28, or the like. Alternatively, the computer system 14 may have a connection 34 to the server 12 wherein the server 12 is used to store the means that allows registered users the ability of adding content, contests and promotions to web properties and more specifically to allow registered users the ability to customize different on-line gaming applications and to store the data generated.

The server 12 and or the computer system 14 may be connected to a communication network 36. The communication network 36 may be any type of communication system. In accordance with one embodiment, the communication network 36 is the internet. The server 12 and or the computer system 14 maybe connected to a communication network 36 via a wired and or wireless connection 32.

A plurality of computer systems 38 may be coupled to the server 12 via the communication network 36. Each computer system 38 may be coupled to the communication network via a wired or wireless connection 35. The computer systems 38 allow customers 60 to access the server 12 in order to play the on-line gaming applications provided by the operator 37 of the server 12. The customers 60 may have to register prior to accessing the on-line gaming applications of the server 12. In accordance with one embodiment, the gaming applications are MMOGs. The computer systems 38 will be similar to the computer systems 14. The computer system 38 may have a processor unit 40 and a display 42. Input devices may be coupled to the processor unit 40. The input devices may be a keyboard 43, a mouse 44 and the like.

The processor unit 40 may have a memory 48 and a central processing unit 50 (CPU). The processor unit 40 may further have an I/O port 46 for downloading data to the processor unit 40. The I/O port 46 may be a USB port, a FireWire port or the like. The listing of the above is given as an example and should not be seen as to limit the scope of the present invention.

One or more customer servers 52 may be coupled to the server 12 via the communication network 36. The customer servers 52 may be connected to the communication network 36 via wired and or wireless connections 53. The customer servers 52 are used for hosting customer websites. The customer servers 52 may be coupled to a customer main computer system 54. The customer main computer system 54 is used for adding content to the customer server 52.

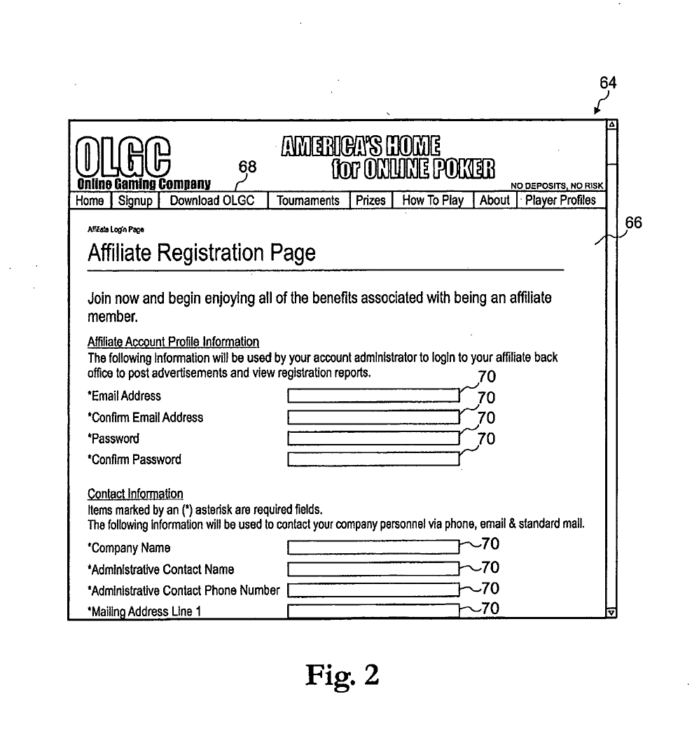

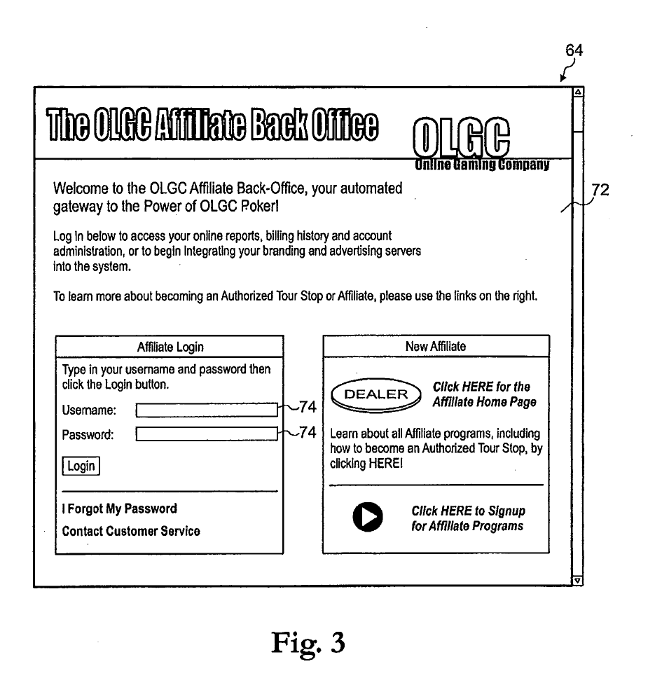

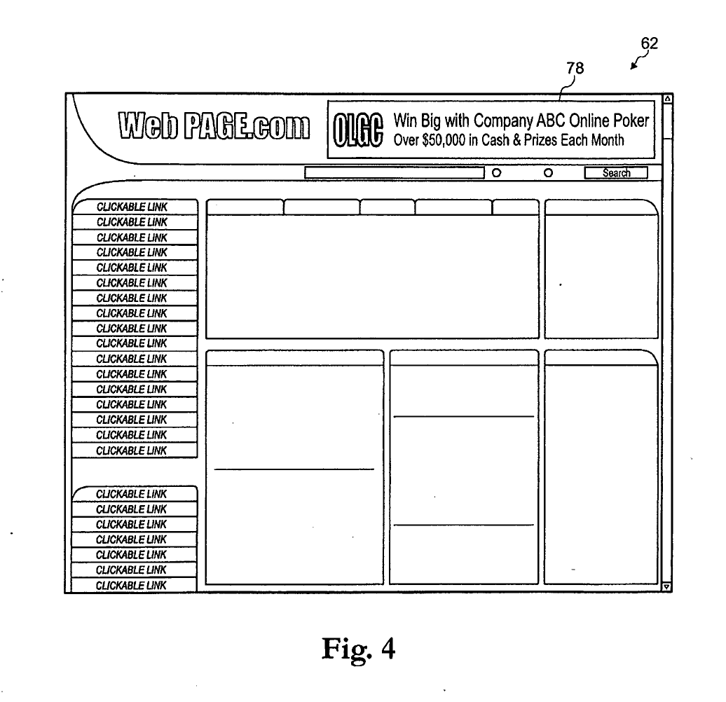

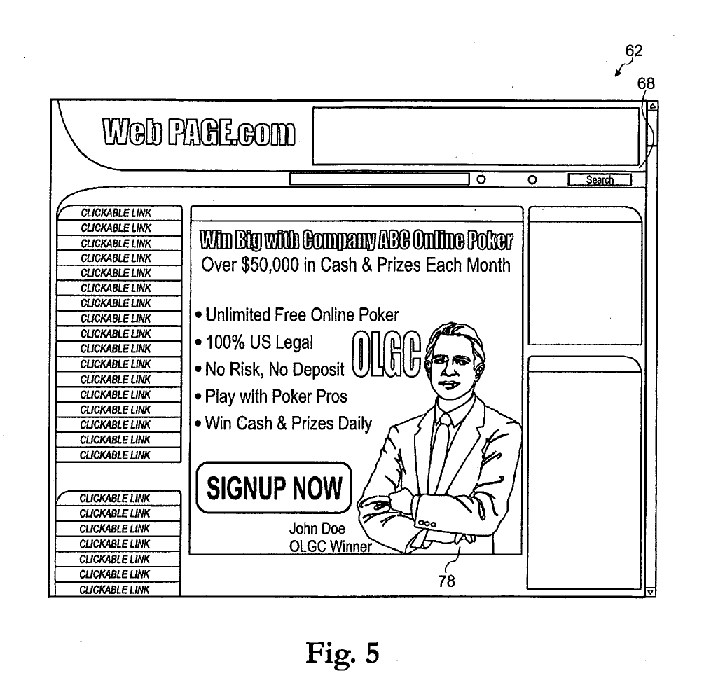

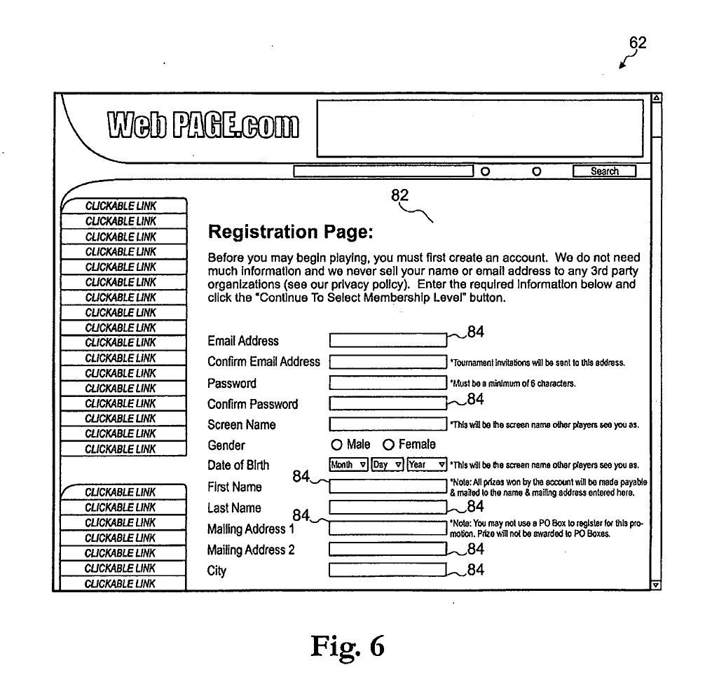

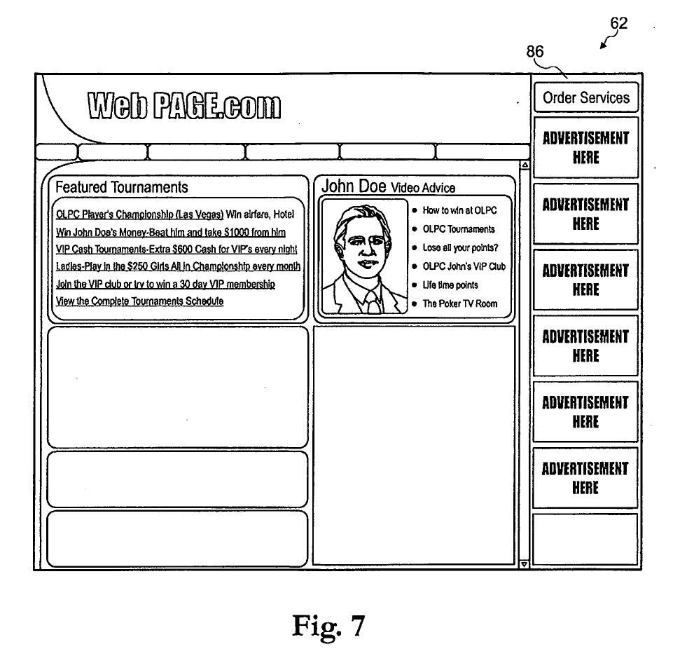

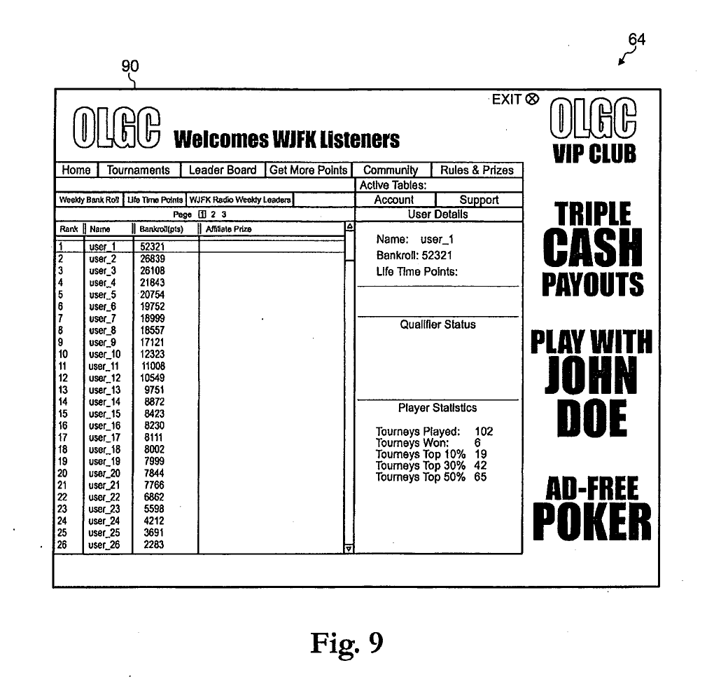

Referring now to FIGS. 1-9, operation of the system 10 will be disclosed. In operation, a customer 60 will used the system 10 to partner with the operator 37 of the system 10 to offer an online promotion. In accordance with one embodiment, the customer 60 will offer visitors of the customer's website 62 a chance to win predetermined prizes (i.e., cash, gifts, etc.) by playing an online game. In accordance with one embodiment, the online game is an online MMOG. The MMOG may be a casino game. As shown in FIG. 7, in the present embodiment, the MMOG is a casino table game.

To get started, the customer 60 will access the operator' s website 64. When a customer 60 accesses the operator' s website 64, the customer may be sent to a registration section 66 of the operator's website 64. Alternatively, the customer 60 may be sent to a home page of the operator' s website 64 where the customer 60 may have to navigate by use of navigation tabs 68 to the registration section 66 of the operator' s website 64. The registration section 66 allows the customer 60 to register as a new customer. If the customer 60 needs to register, the customer 60 may need to enter a plurality of identifying information. The registration section of the operator' s website 64 will have a plurality of fields 70 where the identifying information is entered. The customer 60 will enter identifying information in the different fields. For example, the customer 60 may need to provide information such as, but not limited to: User Name, Password, Company Name, Company Address, and the like.

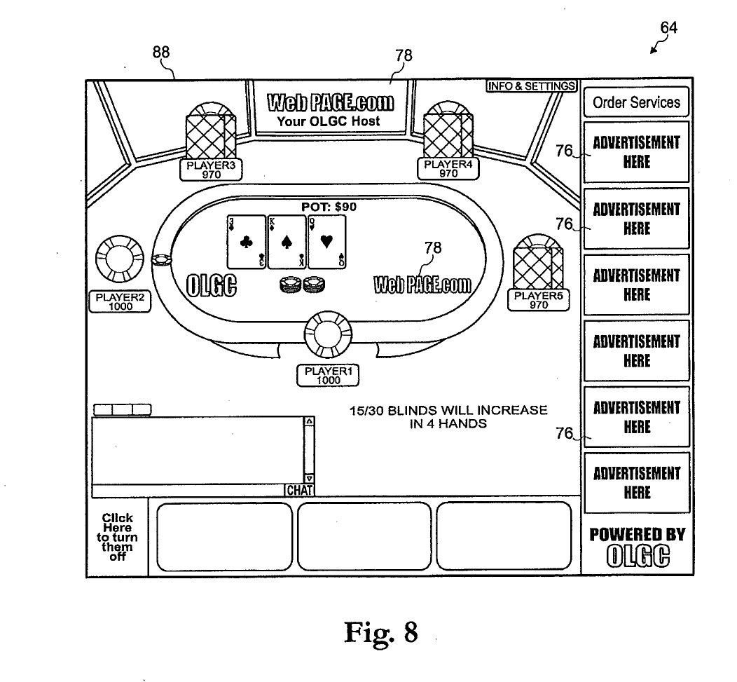

Once the registration information has been submitted and reviewed by the operator 37, the customer 60 will be notified of acceptance or if the customer's request has been declined. The notification may be an email, regular mail, a telephonic message, or the like. In accordance with one embodiment, the notification is an email. If the customer 60 has been approved, the email may contain a confirmation of acceptance and a link to login section 72 of the operator's website 64. In a similar manner, if the customer 60 is already a registered user, the customer will access the login section 72 of the operator's website 64 in order to log into and access the operator's website 64. The login section 72 will have one or more fields 74. The customer 60 may be able to access the operator website 64 by entering at least one of a user name and or a password in the appropriate field 74. Once the user name and or password has been validated, the customer 60 will be sent to the section of the operator's website 64 where the customer 60 may customize a particular gaming application. The section of the operator's website 64 where the customer 60 may customize a particular gaming application allows the customer to select a particular gaming application to use as a promotion. The gaming application may be any type of online gaming application. In accordance with one embodiment, the online gaming application is an online MMOG. The MMOG may be a casino game. As shown in FIG. 8 in the present embodiment, the MMOG is a casino table game and more specifically, a casino poker game.

Once a particular gaming application has been selected, the customer 60 may customize the gaming application. The customer 60 may customize the gaming application by selecting where and how different advertisements 76 may be shown. In accordance with one embodiment, the customer 60 may upload their logos 78 to be seen on the game table, background graphics to be seen behind the table and can insert advertising call tags so that their visitors see their ads while playing the game. Alternatively, the customer 60 may provide links which allows their logos 78 and advertising call tags to be downloaded from the client server 52.

The customer 60 may further have the option of running an invitational tournament for all, or a specific subset (high speed Internet users) of their players. The customer 60 may offer their registered users a private tournament that is only accessible through the entry of a code, password, or by loading an invitation list of specific emails.

The customer 60 may further be provided with banners 78 to be placed on the customer's website 62. The banners 78 will provide advertisement inviting visitors to the customer's website 62 the opportunity to visit the operator's website 64 where the visitor may play different gaming applications. The visitors to the customer's website 62 further may have the exclusive opportunity to play in a customer 60 sponsored only invitational tournament held at the operator's website 64. The different gaming applications may award the winner different prizes. Local league prizes are an option and can be added at any time.

When a visitor to the customer's website 62 clicks on the banner 78 or a link sent via email, the visitor is directed to a customized landing page 68. The landing page 68 may explains about the operator's website 64, reviews the customer's invitational tournament (if applicable), and or provides instructions on how to register. The landing page 68 is customized for each different customer. The landing page 68 may explains the above mentioned via text, audio, and or video means. In accordance with one embodiment, the landing page 68 introduces a site spokesman 80, and reviews the customer's invitational tournament (if applicable), and provides instructions on how to register. The landing page 68 is customized for each different customer 60.

If a visitor decided to participate and become a player of the MMOG, the visitor is taken to a co-branded registration page 82. The registration page 82 has a plurality of fields 84. The fields 84 may be used for each player to enter identifying information. As part of the official rules, each player may have to agree to have the registration data shared. The identifying information to be entered in the fields 84 by each player may include, but is not limited to: Player Name, Player Address, Date of Birth, Sex, Screen Name, Password, Email Address, and the like.

When a player that has registered from an affiliate site (i.e., customer website 62) logs-in to the operator's website 64 to play one of the gaming applications the player is sent to a home page 86 of the operator's website 64. The player is ‘tagged’ as coming from a specific ‘affiliate’ site (i.e., customer website 62) on which the player registered. This means that players that have registered from these sites see a customized or ‘skinned’ presentation layer-extending the affiliates' content seamlessly. Thus, each player sees an entirely different presentation layer based upon the affiliate site (i.e., customer website 62) that particular player registered from. Each player will see different advertisements 76, banners 78, and the like related to the specific ‘affiliate’ site (i.e., customer website 62) on which the player registered from.

When a player selects a particular gaming application, the player is sent to the gaming page 88 selected. Again, the player is ‘tagged’ as coming from a specific ‘affiliate’ site (i.e., customer website 62) on which the player registered. That player sees the customized or ‘skinned’ presentation layer-extending the affiliates' content seamlessly. Each player sees a different presentation layer based upon which affiliate site (i.e., customer website 62) that particular player registered from. Thus, each player will see different advertisements 76, banners 78, and the like related to the specific ‘affiliate’ site (i.e., customer website 62) on which the player registered from. This allows the system 10 to have the different players playing at a single table all seeing different presentation

In the embodiment shown in FIG. 8, each player sees a branded table top showing the logo 78, backdrop, and a % of ads 76 that rotate around the table. In accordance with one embodiment, the logo 78, backdrop, and a % of ads 76 that rotate around the table are called from the affiliate server 52. This increases site visitation metrics and banner ad revenues, promotes cross conversion to other media and allows for targeted marketing to this online constituency.

This also enables web properties to recognize players that have registered from their site at a site-specific basis while also having them compete at a national level. The operator' s website 64 may further have a leaderboard page 90. The leaderboard page 90 presents standings at both a national and affiliate basis.

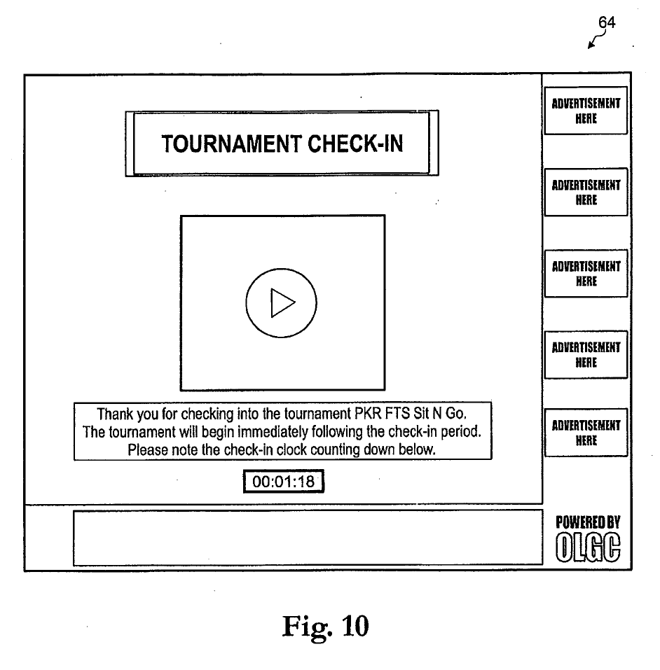

The operator's website 64 may further have a video page 92. Prior to and during pre-programmed game-breaks, a streaming media player may open as shown in FIG. 10. The video page 92 allows customers 60 to showcase ad content or rich-media ads.

Even if you one is not a customer 60, the system 10 may allow any sponsor to deploy a promotional tournament, or series of tournaments, using the operator website 64.

For example: Company XYZ wants to offer their in-store visitors a new promotion. People come into the store and get a card with an invitation code on it. People go to the operator' s website 64 (or through a landing page) and register to play in the Company XYZ Poker invitational. In order to register one must have a code—and of course no purchase is necessary. This could be done with a B2B application also where a national sales force runs a promotion and only the 3,000 sales people around the country can play and they can enter by just putting their Joe@mycompany.com email address in to the tournament registration area.

The system 10 provides the thrill of high-stakes tournament gaming without any of the risk-all wrapped around a branded adver-gaming experience. Customers 60 get to touch their visitors on multiple levels in a casual gaming atmosphere.

While embodiments of the disclosure have been described in terms of various specific embodiments, those skilled in the art will recognize that the embodiments of the disclosure can be practiced with modifications within the spirit and scope of the claims.

What is claimed is:

1. A method of adding advertisements and promotions to web properties comprising:
accessing an online gaming provider by a plurality of companies;
loading advertisement data of the companies to be displayed on a Massively Multi-player Online Game (MMOG);
tagging players as coming from websites of specific companies; and
displaying the advertisement data on the MMOG, wherein each player views advertisement data from the specific company where the player was tagged as visiting.

2. The method of claim 1 wherein loading advertisement data of the companies to be displayed on a Massively Multi-player Online Game (MMOG) further comprise downloading from servers of each company the advertisement data to be displayed on the Massively Multi-player Online Game (MMOG).

3. The method of claim 1 wherein loading advertisement data of the companies to be displayed on a Massively Multi-player Online Game (MMOG) further comprise downloading from a server of the specific company the player is tagged as visiting the advertisement data to be displayed on the Massively Multi-player Online Game (MMOG) when the player logs into the MMOG.

4. The method of claim 1 further comprising inserting banner ads for the online gaming provider in websites of the plurality of companies.

5. The method of claim 4 further comprising directing a person who accesses the banner ad to a landing page which provides information on the online gaming provider.

6. The method of claim 1 further comprising registering with the online gaming provider by the plurality of companies.

7. The method of claim 5 further comprising directing the person who accesses the banner ad to a registration page after the person is first directed to the landing page.

8. The method of claim 1 further comprising displaying video data advertisements at predetermined intervals of the MMOG.

9. A method of adding advertisements and promotions to web properties comprising:
accessing an online gaming provider by a plurality of companies;
loading advertisement data of the companies to be displayed on a Massively Multi-player Online Game (MMOG), the advertisement data being downloaded from servers of each of the plurality of companies;
inserting banner ads for the online gaming provider in websites of the plurality of companies;
tagging players as coming from a specific website of a specific company when a person accesses the banner ad of the specific company; and
displaying the advertisement data on the MMOG, wherein each player views advertisement data from the specific company where the player was tagged as visiting.

10. The method of claim 9 further comprising directing a person who accesses the banner ad to a landing page which provides information on the online gaming provider.

11. The method of claim 9 further comprising registering with the online gaming provider by the plurality of companies.

12. The method of claim 10 further comprising directing the person who accesses the banner ad to a registration page after the person is first directed to the landing page.

13. The method of claim 10 further comprising displaying video data advertisements at predetermined intervals of the MMOG.

14. The method of claim 10 further comprising hosting of private MMOG by a hosting company.
